(19) United States
(12) Patent Application Publication
(10) Pub. No.: US 2014/0278956 A1
(43) Pub. Date: Sep. 18, 2014

(54) IMAGE PROCESSING APPARATUS

(71) Applicants: Takahiro ASOH, Tokyo (JP); Kiyohiko SHINOMIYA, Tokyo (JP); Shigeo NEGORO, Tokyo (JP)

(72) Inventors: Takahiro ASOH, Tokyo (JP); Kiyohiko SHINOMIYA, Tokyo (JP); Shigeo NEGORO, Tokyo (JP)

(21) Appl. No.: 14/204,944

(22) Filed: Mar. 11, 2014

(30) Foreign Application Priority Data
Mar. 12, 2013 (JP) 2013-049591

(51) Int. Cl. G06Q 30/02; G06F 3/12

(52) U.S. Cl. CPC G06Q 30/0251; G06F 3/1296
USPC 705/14.49

(57) ABSTRACT

An image processing apparatus is provided, to display advertisements with good timing to an image processing device that a user is currently using, so that the frequency of reference to the advertisement can be improved. The image processing apparatus includes circuitry configured to: manage the processing of a job requested by a user, and manage advertisements to be displayed in accordance with a job classification of the job being processed; and a display configured to display an advertisement, wherein the circuitry is further configured to stop and resume the processing of the job in accordance with at least one of a display status of the advertisement displayed by the display and a display condition of the advertisement displayed by the display.

### CROSS-REFERENCE TO RELATED APPLICATIONS

This patent application is based on and claims priority pursuant to 35 U.S.C. §119 to Japanese Patent Application No. JP 2013-049591, filed on Mar. 12, 2013, in the Japan Patent Office, the entire disclosure of which is hereby incorporated by reference herein.

### BACKGROUND

1. Field of the Disclosure

This invention relates to the control technique of an image processing apparatus.

2. Description of the Related Art

With video display apparatuses, such as a liquid crystal display installed outdoors, at a shop front, etc., the digital signage that displays guidance information, advertisement, etc., to a person who is close, or to a passing person, is beginning to be used.

Moreover, a technique has been proposed that makes use of the digital signage to collect input information from a user, and prints a coupon according to the content. In patent document 1 (JP2010-218489), a structure is disclosed that is capable of input of information through a touch panel by those who access a display terminal in a digital signage system for the purpose of acquisition of trend information (trend research).

As mentioned above, various devices are made regarding digital signage, however, the frequency with which a user tends to go in front of an advertising display of an old digital signage system is low. The opportunity for a user to look at an advertisement is also low. Furthermore, there existed a problem that it was also difficult to promote the information input from a user.

### SUMMARY

The present invention has been proposed in view of the conventional problems described above. It is an object of the invention to display an advertisement to a user with good timing and to improve the frequency of reference to the advertisement, using an image processing apparatus, such as an MFP (Multi Function Peripheral, Multi Function Printer).

In order to solve the conventional problems, the present invention provides an image processing apparatus, comprising: a job management means for managing the process of a job requested by a user, an advertisement management means for managing advertisements to be displayed in accordance with a job classification of the job being processed; and an advertising and display means for displaying an advertisement, wherein the job management means is configured to stop and resume the processing of the job in accordance with a display status of the advertisement by the advertising display means.

According to the invention, and by making use of image processing apparatuses, such as MFP, to display advertisements with good timing to the image processing device that the user is currently using, the frequency of reference to the advertisement can be improved.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure will be readily obtained as be better understood by reference to the description when considered in connection with the accompanying drawings, wherein:

FIG. 1 shows a configuration of an image processing apparatus according to an exemplary embodiment;

FIG. 2 shows a flow of application operation data when the application of an operation part or a terminal part utilizes the function of a main-body part;

FIG. 3 shows an example of an appearance of an operation part;

FIG. 4 shows an exemplary software configuration of the main-body part and the operation part;

FIGS. 5A-5B show an exemplary process sequence of an advertising display according to an embodiment;

FIG. 6 shows another exemplary process sequence of an advertising display according to an embodiment; and

FIG. 7 is a flowchart showing a process example of an advertisement management module according to an embodiment.

### DETAILED DESCRIPTION OF THE EMBODIMENTS

Referring now to the drawings, wherein like reference numerals designate identical or corresponding parts throughout the several views, hereinafter, preferred embodiment of this invention is described.

FIG. 1 is a diagram showing a configuration of an image processing apparatus 1 according to an exemplary embodiment of the present invention. The image processing apparatus 1 is equipped with a main-body part 2 and an operation part 3. The main-body part 2 and the operation part 3 are connected by a cable 4. Instead of a wired connection using cable 4, the operation part 3 and the main body part 2 may be connected wirelessly (including infrared).

Even if the load of the main-body part 2 is high, the image processing apparatus 1 can avoid reducing the operation response by making the part that performs a screen display and operation of a key input independent of the main-body part 2 and the operation part 3. Independent OS (Operating System), such as Android OS, is mounted in the operation part 3, and it operates independently of the main-body part 2.

The main-body part 2 includes a main-body-part controller 21, for controlling operation of the main-body part 2, a scanner device 22 for reading a document, and a plotter device 23 for printing on paper.

The main-body part 2 can receive access from the terminal device 6, such as a PC (Personal Computer), through the network 5, such as a LAN (Local Area Network), WAN (Wide Area Network) and the Internet, etc. Also, main-body part 2 can receive access from the terminal device 8, such as a smartphone, tablet, or the like, through a wireless access point 7. It may make it access the main-body part 2 directly using short-distance wireless, such as Bluetooth, from the terminal device 8. It is also possible to directly access the main-body part 2 with a short-range wireless, such as Bluetooth, from the terminal device 8.

The operation part 3 includes an operation part controller 31 that manages the control action of the operation part 3, a hard key 32 that a user operates, a liquid-crystal touch panel 33 that performs a screen display and an operation input reception, and a wireless communication part 34 that performs wireless communication by wireless LAN (Wi-Fi, etc.), etc. The operation part 3 can perform data communication with any device via the wireless access point 7 by the wireless communication part 34.

FIG. 2 is a diagram showing the flow of the application operation data when the application of the terminal device 6 and 8 or the operation unit 3 uses the function of the main-body part 2.

In FIG. 2, the basic software for operating each system is arranged in the OS layer. Background functions, such as device control, process control, and memory control, are provided to the upper layer. The service layer is arranged to provide process control services for controlling the system (power control, user management, authentication management, network management, etc.). The application layer is arranged to implement the process of each function (printer, scanner, FAX, etc.) of the image processing apparatus 1 (application).

The operation part 3 is supplied with a power supply line and a control line by cable 4 from the main-body part 2. Application operation data from the application layer of the operation unit 3 is transmitted to the service layer of the main body portion 2 through the cable 4. Application operation data from the application layer of the terminal devices 6 and 8 is transmitted to the service layer of the main-body part 2 via the network 5.

FIG. 3 is a diagram illustrating an example of appearance of the operation part 3.

In FIG. 3, the liquid crystal touch panel 33 that can be operated by touch panel is provided on the front of the operation unit 3, and the liquid crystal touch panel 33 is operable by hard key 32 disposed next to it even when off (OFF). The screen of the operation part application is displayed on the liquid crystal touch panel 33. In the hard key 32, keys that are used in common on each screen are displayed, allocated as “Back”, “Home Screen,” and “Stop”, etc. It is also possible to change allocation into the hard key 32 by a user's customization.

FIG. 4 is a diagram showing an exemplary software configuration of the main-body part 2 and the operation part 3. In an application layer, printer application A21 for printing and scanner application A22 are arranged for reading of a document.

In the application layer of the operation part 3, a display module A31 that displays advertisements, and an advertisement management module A32 to manage the advertisement displayed according to the job classification of the job in process, are placed.

Note that the features included in the main-body part 2 or the operation part 3 need not be implemented within the operating unit 3 or the main body portion 2, but may be implemented as features available on the network.

FIGS. 5A-5B are a sequence diagram showing a process sequence of an advertising display according to an embodiment. In this case, the application on the main-body part 2 (printer application A21, scanner application A22), plotter device (engine) 23 for printing to paper, and the job management module M21 of the service layer that manages the job processing requests from the application, are shown, as well as the application on the operation part 3 (display module A31, advertising management module A32).

In FIGS. 5A-5B, when a user provides printing instruction to the image processing apparatus 1 via a network from the terminal devices 6 and 8, data is received on the network I/F of the main-body-part controller 21, and the job is passed to the printer application A21. Upon receiving the data, printer application A21 will perform the print job and notify the job management module M21 (step S101).

If the user intends to use the scanner at the front of the image processing apparatus 1 at the same time, to perform a scan job, scanner application A22 will perform the scanning job and notify the job management module M21 (step S102).

The job management module M21 refers to the setting of the priority application held in NVRAM (Non Volatile Random Access Memory) or the like, in order to determine the priority of the processing of the job for which it received notification (step S103). It should be noted that the priority application setting is a parameter that is user-configurable by default. Since priority is given to the user in front of the image processing apparatus 1, the scanner process is adapted to be preferred by default. Here, it is assumed that the priority application setting has been changed by the user and presupposes that priority is given to a printer.

The job management module M21 determines the processing order (in this case, the decision to print according to the priority application setting), and provides notification of the job processing start of printing with respect to advertising management module A32 of the operation part 3 (step S104).

Advertisement management module A32 receives the notification of a job processing start of printing, and performs an advertising display by display module A31 (step S105). In addition, the detail of a process of an advertising display (step S105) will be described later.

Moreover, the job management module M21 provides a start-of-printing notification to printer application A21 at the same time as the notification of a job processing start (step S106).

In parallel with display advertising, printing is performed on request to the plotter device 23 by printer application A21 (step S107). The plotter device 23 processes a job, waits for the advertising display completion notification to process the job, and outputs the final page (step S108).

The job management module M21 will perform notification of advertising display completion with respect to printer application A21, when an advertising display is completed (step S109).

Printer application A21 makes a job processing completion request with respect to the plotter device 23 (step S110). The plotter device 23 outputs the final page (step S111).

Then, the job management module M21 provides notification of a job processing start of a scanner with respect to the advertisement management module A32 of the operation part 3 (step S112).

Advertisement management module A32 receives the notification of a job processing start of a scanner, and performs an advertising display by display module A31 (step S113). In addition, the detail of a process of an advertising display (step S113) will be described later.

Moreover, the job management module M21 provides a reading start request to scanner application A22 at the same time as the notification of a job processing start (step S114).

In parallel to an advertising display, scanner application A22 starts reading with the scanner device 22 (FIG. 1) (step S115), and it waits until the notification of advertising display completion comes.

The job management module M21 will perform notification of advertising display completion with respect to scanner application A22, when an advertising display is completed (step S116).

Scanner application A22 makes a reading completion display request with respect to display module A31 of the operation part 3 (step S117), and display module A31 displays the message that the reading of the scanner original document completed (step S118).

In this way, advertising display completion is followed by a printout of the final page in the case of printing, and displays a reading completion message in the case of the scanner.

The printing via a network was demonstrated as an example of printing, however, it can also apply when carrying out the printing instruction jobs (Document Box) stored in a HDD (Hard Disk Drive) of the main-body part 2, etc.

FIG. 6 is a sequence diagram showing the process example of an advertising display (FIG. 5, S105, S113).

In FIG. 6, the process is started in response to the job processing start notification from the job management module M21 of the main-body part 2, advertisement management module A32 judges the city by referring to an advertising display setting, and it is determined whether an advertising display is carried out or is not carried out (step S201). Equipment can be configured by the administrator in advance for display ads and the completion time of a display to be displayed on each application when using the ON/OFF and advertising display settings, or each application utilization.

Advertisement management module A32 selects the advertisement (image) to display, when an advertising display setting is ON (step S202).

Advertisement management module A32 notifies the selected advertisement to display module A31 (step S203).

Display module A31 displays the still image or video of the advertisement (step S204).

Advertisement management module A32 makes an advertising display completion request with respect to display module A31 after the completion time of a display of the still image or video retained as a part of advertising display setting, to terminate the advertising display (step S205).

At the same time as the completion of the advertising display, on the other hand, advertisement management module A32 transmits a notification of advertising display completion with respect to the job management module M21 of the main-body part 2 (step S206).

FIG. 7 is a flowchart showing a process example of an advertisement management module A32.

In FIG. 7, advertisement management module A32 waits the notification of a job processing start (step S301), and when the notification of a job processing start is received from the job management module M21 of the main-body part 2 (YES of step S302), an advertising display setting will be referenced (step S303). When an advertising display setting is ON (YES of step S304), an advertisement is selected (step S305), and an advertising display request is given to display module A31 (step S306).

Advertisement management module A32 makes an advertising display completion request with respect to display module A31 (step S307), and only after the completion time of a display of an advertising display setting performs the drawing process of an advertisement (step S308).

Finally, advertisement management module A32 provides notification of advertising display completion to the job management module M21 of the main-body part 2 (step S309), and returns to waiting for the notification of a job processing start (step S301).

When an advertising display setting is OFF (NO of step S304), the display of advertisement is not performed, but the notification of advertising display completion is provided to the job management module M21 of the main-body part 2 (step S309), and it returns to waiting for the notification of a job processing start (step S301).

In this example, after waiting only for the completion time of a display in advertisement management module A32, the advertising display termination request is made. However, it is also possible to receive the user input (questionnaire input with respect to advertisement, etc.) with respect to advertisement by the touch panel of the operation part 3, and to provide notification of a termination request depending on the result.

### SUMMARY

As described above, according to an embodiment, by utilizing an image processing apparatus, such as an MFP, the frequency of reference to an advertisement can be improved by displaying advertisements with good timing on the image processing apparatus that a user is using.

Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

The invention has been described above in the form of a preferred embodiment of the present invention. While the invention has been described by showing particular embodiments herein, various modifications and changes to these specific examples will be is apparent without departing from the broader spirit and scope of the invention as defined in the claims. That is, the present invention is not to be construed as being limited by the accompanying drawings and details of the specific examples.

What is claimed is:

1. An image processing apparatus, comprising:
circuitry configured to:
manage the processing of a job requested by a user, and
manage advertisements to be displayed in accordance with a job classification of the job being processed; and
a display configured to display an advertisement,
wherein the circuitry is further configured to stop and resume the processing of the job in accordance with at least one of a display status of the advertisement displayed by the display and a display condition of the advertisement displayed by the display.

2. The image processing apparatus according to claim 1, wherein the circuitry is further configured to change the priority of a process of the job requested by the user based on setting information that can be changed.

3. The image processing apparatus according to claim 1, wherein the circuitry is further configured to complete a display of the advertisement by progress of a completion time of the display based on setting information that can be changed.

4. The image processing apparatus according to claim 1, wherein the circuitry is further configured to receive user input with respect to the advertisement.

5. An image processing method, comprising:
processing, using circuitry, a job requested by a user;
managing, using the circuitry, advertisements to be displayed in accordance with a job classification of the job being processed; and
displaying, using a display, an advertisement,
wherein the circuitry is further configured to stop and resume the processing of the job in accordance with at least one of a display status of the advertisement displayed by the display and a display condition of the advertisement displayed by the display.

6. A non-transitory computer readable storage medium encoded with instructions, which when executed by an image processing apparatus cause the image processing apparatus to execute an image processing method, comprising:
processing, using circuitry, a job requested by a user;
managing, using the circuitry, advertisements to be displayed in accordance with a job classification of the job being processed; and
displaying, using a display, an advertisement,
wherein the circuitry is further configured to stop and resume the processing of the job in accordance with at least one of a display status of the advertisement displayed by the display and a display condition of the advertisement displayed by the display.
